(19) United States
(12) Patent Application Publication
(10) Pub. No.: US 2021/0298146 A1
(43) Pub. Date: Sep. 23, 2021

(54) REGULATOR FLICKER CONTROLLER CIRCUITRY FOR ELECTROLYTIC-CAPACITOR-LESS AC-DC LED DRIVER UNDER UNIVERSAL INPUT VOLTAGE

(71) Applicant: Vidatronic Egypt, Cairo (EG)

(72) Inventors: Mohamed ORABI, Cairo (EG); Mahmoud NASSARY, Cairo (EG)

(73) Assignee: Vidatronic Egypt, Cairo (EG)

(21) Appl. No.: 17/331,609

(22) Filed: May 26, 2021

Related U.S. Application Data
(63) Continuation-in-part of application No. 17/209,118, filed on Mar. 22, 2021.
(60) Provisional application No. 62/992,986, filed on Mar. 21, 2020.

(51) Int. Cl. H05B 45/37; H05B 45/36

(52) U.S. Cl. CPC H05B 45/37; H05B 45/36

(57) ABSTRACT

A driver system for an LED chip includes an EMI filter, wherein a first port of the EMI filter is connected to a line voltage; a rectifier bridge, wherein a first port of the rectifier bridge is connected to a second port of the EMI filter; a DC-DC power converter, wherein a first port of the DC-DC power converter is connected to a second port of the rectifier bridge; an output stage connected to a second port of the DC-DC power converter; and a flicker controller including two input ends and one output end, wherein a first input end is connected to an output stage to sense a signal of an output current, wherein the one output end is connected to a switch of the DC-DC power converter, wherein the second input end is connected to a common coupling point of a voltage divider circuit to sense an input voltage.

### CROSS REFERENCE TO RELATED APPLICATIONS

This is a Continuation-In-Part of application Ser. No. 17/209,118 filed on Mar. 22, 2021, which claims the benefit of provisional application No. 62/992,986 filed on Mar. 21, 2020. The disclosures of these prior applications are incorporated by reference in its entirety.

### FIELD OF THE INVENTION

The invention relates to a control system for electrolytic-capacitor-less AC-DC power converter drivers with low flicker for LED applications.

### BACKGROUND OF THE INVENTION

LED technology has several merits over conventional lamps such as: high-efficiency, very long lifespan (approximately 100,000 hours), lower power consumption, low maintenance cost, and instantaneous switch-on. In addition, the LEDs are environmentally friendly. Regarding their efficiency, CREE claimed to be the first company to break the 300 lumens per watt barrier (still being the highest level achieved). Moreover, lighting consumes 20% of the electrical energy in the industrialized countries, which are pushing forward with the replacement of conventional lighting with LED lighting.

The critical part that defines the LED lamp lifespan is the driver. One-stage AC-DC LED drivers normally use a bulky electrolytic capacitor (E-Cap) to balance power between the pulsating input and the constant output, minimizing the double line frequency current ripple. This capacitor limits the lifespan of the LED lamp to its own lifespan, typically between 1000 and 10,000 hours, considerably lower than the lifespan of LEDs. In addition, the lifespan of the E-Caps follows the 10-degree-law, i.e., it decreases by a factor of 2 for each +10° C. temperature increase. Even assuming this, operations at 85° C. only push E-Caps lifespan to 20,000 hours. Consequently, eliminating the E-Cap is mandatory and many research efforts have been made in this direction.

Wound and soft winding film capacitors can be used instead of E-Caps due to their long lifespan. However, their energy density is low and that increases the output voltage and the output current ripple of the LED driver. This causes a depraved effect on the LED chip. The light perceived by human eyes is proportional to its average value because the light ripple is filtered as long as its frequency is higher than a few hundreds of hertz. Nonetheless, increasing LED peak current (as a consequence of the ripple) results in changes in the chromaticity coordinates, color correlated temperature (CCT), color rendering index (CRI), flux, and efficacy degradation, such that LED light is perceived as bluish white.

In the prior art, an AC-DC converter disclosed in U.S. Pat. No. 9,300,217 generates an output voltage and includes a current ripple eliminator. This AC-DC converter has an input terminal, an energy storage capacitor, and an output terminal, wherein the input terminal had an input voltage, the output terminal generates a pure AC component of a voltage feedback signal based on the output voltage. When the input voltage is larger than a first reference voltage, the energy storage capacitor stores a difference between the input voltage and the first reference voltage as an electric energy. Otherwise, the energy storage capacitor releases the electric energy to the input voltage to minimize the ripple of an output power thereof.

The AC-DC converter of the '217 patent has many disadvantages due to its use of an extra converter for ripple cancelation. Adding more converter with two more switches can increase the costs for the LED lamp technology and make it unaffordable for the end users. On top of that, the control complexity is one of the disadvantages for this circuitry, wherein the controller should have the ability to control two different operating points for two different converters. Another concern of the AC-DC converter of the '217 patent is the efficiency, using another converter to process the power makes the efficiency drop that will dramatically affect the LED driver efficiency.

U.S. Pat. No. 9,338,843 discloses an LED driver that uses a rectifier, a power factor correction subcircuit, a voltage conversion subcircuit, and a semiconductor switch. The power factor correction subcircuit uses a film capacitor instead of an electrolytic capacitor. In addition, the power factor correction subcircuit uses either an inductor or a transformer to reshape the incoming current to a substantially sinusoidal waveform that is in phase with the input AC current. The semiconductor switch provides a high frequency pulsating triangular current at the output of the rectifier.

The LED driver circuit of the '843 patent uses several extra components. It has five semiconductor switches, which significantly increase the solution cost. Furthermore, it has more than three capacitors, which also have effects on the solution cost and market penetration. One of the main advantages of this circuit is that it has isolation between the input and the output LED load by using a high frequency transformer. Therefore, the energy density of this invention is questionable. Finally, it has a limitation on the range of operating input voltage, where it is proposed that the converter operates only from 85V-120V RMS. This limitation makes it applicable only in specific countries that have 100 or 110V rms.

U.S. Pat. No. 9,648,684 proposes to utilize an internal high frequency capacitor of the LED chip to replace the smoothing bulky electrolytic capacitor in a conventional buck converter in a power supply application. LED lighting systems usually have multiple connection of LEDs strings for better illumination and can reach several dozens of LEDs. Such a configuration can be utilized to enlarge the total internal capacitance, hence minimize the output LED current ripple. Furthermore, the switching frequency of the buck converter was selected such that minimum ripple appears at the output current. The functionality of this design was confirmed experimentally, and the efficiency of the drive is 85% at full load.

The idea to use the parasitic high frequency LED capacitor rather than using an actual capacitor seems a good one from the theoretical point of view. The main disadvantage is that this parasitic capacitor has a very small value in comparisons with the actual passive element capacitor. Moreover, its capacitance changes with the current frequency and current average value, as shown in the '684 patent. This methodology can be applicable in very low power application (e.g., less than 5 W), wherein the needed stored energy in the capacitor for this low power application is low. It is a rule of thumb that the capacitor energy equation equals to the capacitance multiply by the square of the voltage applied on this capacitor. In conclusion, the approach in the '684 patent didn't report any proof of its compliance with the solid stage lighting standards, such as the California Title 24 flicker standard, IEC61000 3-2 for harmonics standard, and the Energy Star standard for power factor.

U.S. Pat. No. 9,837,925 provides a capacitorless AC-DC passive converter power supply. The power supply includes one or more rectifier cells which having inductive and synchronous elements and removing any capacitive filter elements, thereby ensuring a very high Mean Time Before Failure (MTBF) on the rectifier stage. The output voltage and current generated by the one or more inductive cells is a DC signal having a ripple amount dependent upon the number of cells implemented. The approach in the '925 patent has no semiconductor switches nor capacitive elements; it only depends on the inductance as a filter element. To achieve a very low ripple value at the output, it proposes to add more inductive cells, which decreased the energy density of the converter, wherein the size would increase significantly. Basically, this kind of passive element converter suffers from non-output regulation due to the open loop system and setting the operating point to a single specific input and output value wherein the LED chip current is prone to the change due to change in the input voltage or other dynamics such as the temperature increase in the LED chip.

While these prior art approaches provide reasonable solutions, there is still a need for better AC-DC LED driver converters.

### SUMMARY OF THE INVENTION

Embodiments of the invention relate to new control circuitries for driving AC-DC electrolytic capacitor-less LED driver converters with low flicker values and long lifetimes. The new control circuitries are structured based on injection of designed harmonic orders' values to limit the LED current fluctuation, keep the input power factor (PF) high (e.g., higher than 0.9), and maintain a lower flicker value (e.g., to meet the relevant regulations or standards). Moreover, a control circuitry of the invention can regulate the average LED current values in a wide range of input voltages. Such a new control circuitry, which may be referred to as a regulated flicker control block, may be implemented using a feedback loop to reshape the required duty cycle and regulate the output LED current formed by a second-order or other higher-order compensator with an adapted gain that is based on the input voltage value. Such control circuitries can be applied to different converter topologies, such as single-switch topologies or two-stage topologies, that have an intermediate low energy density capacitor. Results show good agreements between simulations and experimentations and confirm that these converters comply with the ENERGY STAR, EN 61000-3-2 Class C, and California flicker Title24 standards.

One aspect of the invention relates to LED driver systems for driving LED chips or multiple strings of LEDs chips. An LED driver system in accordance with one embodiment of the invention comprises an EMI filter with two ports, wherein a first port of the EMI filter is connected to a line voltage; a rectifier bridge with two ports, wherein a first port of the rectifier bridge is connected to a second port of the EMI filter; a DC-DC power converter with two ports, wherein a first port of the DC-DC power converter is connected to a second port of the rectifier bridge; an output stage connected to a second port of the DC-DC power converter; and a flicker controller comprising a two input ends and one output end, wherein a first input end is connected to an output stage to sense a signal indicative of an output current, wherein the one output end is connected to a switch of the DC-DC power converter, wherein the second input end is connected to a common coupling point of a voltage divider circuit to sense an input voltage.

In accordance with some embodiments of the invention, a flicker controller may be used as a regulator with specified bandwidth (e.g., 100-500 Hz) to regulate the LED output current. In accordance with some embodiments of the invention, a flicker controller may be used to inject a predefined harmonic to the control loop such that an output current flicker and an output current peak to average ratio (PTAR) are limited. In accordance with some embodiments of the invention, a flicker controller may be used for duty cycle shaping and/or output current shaping. A flicker controller of the invention may be implemented by using a second order compensator, a third order compensator, or a fourth order compensator. A DC-DC power converter is used for transferring a power from an input port to a regulated output port. A topology of the DC-DC power converter may have an intermediate storage capacitor. The capacitor may be a ceramic capacitor or a film capacitor. A topology of the DC-DC power converter may be a single switch converter or a two-stage converter.

In accordance with some embodiments of the invention, the output stage comprises an LED inductor comprising a first end and a second end, wherein the first end of the LED inductor is connected to a first common coupling point, where a first end of the capacitor is also connected; an LED module comprising a LED chip or a string of multiple LED chips, wherein the LED module has an anode and a cathode, wherein the anode of the LED module is connected to a second end of the LED inductor; and a sense resistor comprising a first end and a second end, wherein the first end of the sense resistor is connected to a common coupling point, where the cathode of said LED module and the first input end of the flicker controller are connected, and the second end of the sense resistor is connected to ground.

Other aspects of the invention will become apparent with the following detailed description and the accompanying drawings.

### BRIEF DESCRIPTION OF THE DRAWINGS

FIG. 1 shows a block diagram of a control system according to one embodiment of the invention. This control circuitry has two inputs. The first input is a sensed LED output current (using a current sensor) or a sensed input voltage (using a voltage sensor). Note that these current and voltage sensors may be implemented using several ways, such as a simple sense resistor or a current mirror for the current sensor. Also, a resistance divider or peak voltage detection may be used for the voltage sensor. The output of the regulated flicker control block is modulated by a conventional Sawtooth generator to generate a PWM to drive a switch. The next block is an AC-DC converter, which can be model as one of: singles-stage or two-stage converters with intermediate small storage capacitor.

FIG. 2 shows a circuit diagram for a control system that has an EMI filter, full bridge rectification, a DC-DC power stage, an LED load, and a flicker controller according to one embodiment of the invention. The capacitor may be a film or ceramic capacitor. The converter may operate in a discontinuous conduction mode (DCM). The load is an LED chip.

FIG. 3 shows a circuitry of a flicker controller according to one embodiment of the invention. It has two loops: one loop is to sense the output current, which is regulated by a compensator that has input impedance of Zin and feedback impedance of Zf, and the other loop is to sense the input voltage by using a voltage simple divider of the rectified voltage. The sensed rectified voltage can be processed to detect its peak by a peak detector compromise with a diode and a capacitor. A comparator is used to distinguish between the two input voltages mode by comparing the peak of the sensed input voltage with a reference voltage. The output of the comparator controls a switch that is connected in series with the compensator impedance to change its gain online.

FIG. 4 shows a schematic for the functions of a flicker controller in accordance with one embodiment of the invention. First, the flicker controller is used for current regulation to regulate the average of the LED current. The second and third functions are to apply flicker control functions to reduce the LED flicker percentage value to be less than 30% based on California standards and to adjust the required duty cycle for maintaining a high power factor (e.g., PF more than 0.9) through reshaping the sensed output signal by injecting predefine harmonics values.

### DETAILED DESCRIPTION OF THE INVENTION

Embodiments of the invention relate to new control circuitries for driving DC-DC electrolytic capacitor-less LED driver converters. These circuitries enable the LED lights to have low flicker values and long lifetimes. These control circuitries may be referred to as regulated flicker control circuitries. In accordance with embodiments of the invention, these control circuitries may be based on injection of designed harmonic orders' values to limit the LED current fluctuation, to keep the input PF high (e.g., higher than 0.9), and to maintain a lower flicker value (e.g., less than 30% flicker rate according to California Title 24 standards). Embodiments of the invention can regulate average LED current values in a wide range for the input voltage.

In accordance with embodiments of the invention, a regulated flicker control circuitry may be implemented using a feedback loop to reshape the required duty cycle and regulate the output LED current formed based on the input voltage value, using a second-order or other higher orders compensator with an adopted gain. A control circuitry of the invention can be applied to different converter topologies, such as single-switch topologies or two-stage topologies that have an intermediate low energy density capacitor. With these properties, converters with control circuitries of the invention can comply with ENERGY STAR, EN 61000-3-2 Class C, and California flicker Title 24 standards.

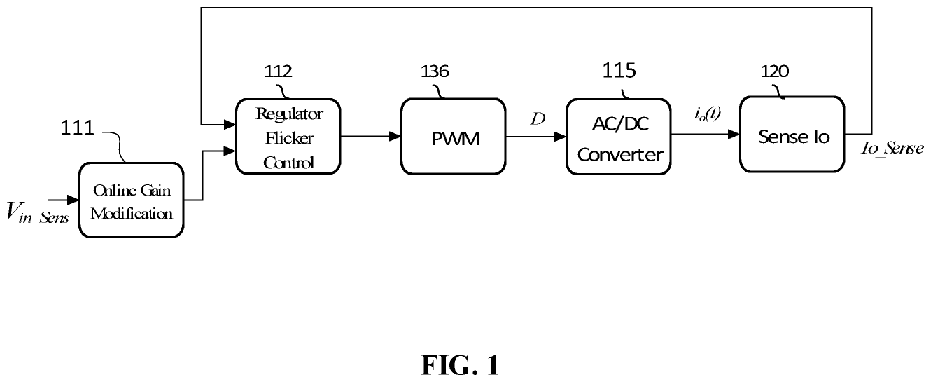

FIG. 1 shows a block diagram for a control system in accordance with one embodiment of the invention. The control system comprises a regulator flicker control 112, a pulse width modulator (PWM) 136, an AC/DC converter 115, and an output current (Io) sensor 120. The regulator flicker control 112 has two inputs: the first input is an output current (Io) from the Io sensor 120 and the second input is an input voltage that may be passed through an online gain modifier 111. The output current (Io) is sensed not only for the regulation purpose, but also for modifying its shape for the flicker standard. This system may include an adopted gain based on the input voltage for the compensator block for the universal AC-DC converter to drive the LED chip.

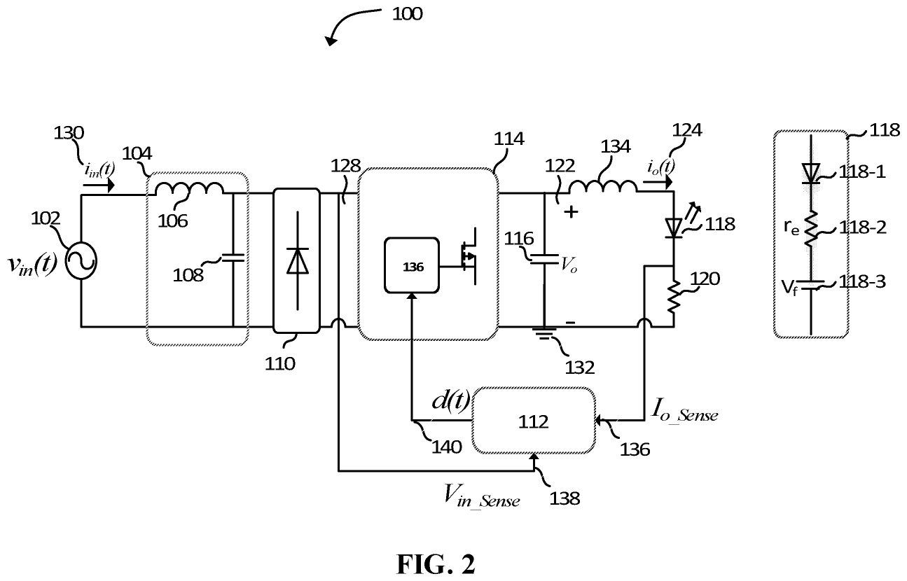

FIG. 2 shows a whole circuit diagram of an LED driver with a regulated flicker control circuit 112 in accordance with an embodiment of the invention. The circuit comprises an electromagnetic interference (EMI) filter 104 to prevent the high frequency harmonics present in the input current from flowing into the grid. A rectified bridge 110 (bridge rectifier) may then be used to rectify the input sine wave voltage 102. The next stage is a DC-DC converter 114, which is used to generate an output voltage from the line voltage 128 to the LED chip voltage, which is used to drive the LED chip module 118. The LED chip module 118 may be any suitable LED chip module, which may comprise a single LED chip or multiple LED chips that may be connected in series and/or in parallel or mixed connection. In this example, the LED chip model 118 is presented as one having three parts: a diode 118-1, a small dynamic resistor rₑ 118-2, and a DC source representing the forward voltage V_{f} 118-3. The LED chip module 118 may be a true module that will not have a mismatch between the mathematical analysis and practical results.

The conventional type of capacitor used in DC-DC converters in LED drivers are electrolytic capacitors, which suffer from high equivalent series resistor and their lifetimes are inversely proportional to the capacitor temperatures. Thus, replacing this type of capacitor is necessary in order to increase the LED driver lifetime. In accordance with embodiments of the invention, such capacitors may be replaced with film or ceramic capacitors. For example, the converter filter output capacitor 116 of FIG. 2 has a small capacitor value, which may depend on the capacitors used. For example, for a 50 W LED driver, a capacitor value of less than 5 μF (e.g., 0.01-5 μF, preferably 0.1-5 μF, more preferably 1-5 μF) may be used for a film or ceramic capacitor. For a converter with an intermediate capacitor, this film or ceramic capacitor may have a capacitance of less than 12 μF (e.g., 0.01-12 μF, preferably 0.1-12 μF, more preferably 1-12 μF) for a 50 W LED driver. By using such non-electrolytic capacitors, the lifetimes of LED drivers can be increased.

As noted above, the regulated flicker control circuit 112 (also referred to as a flicker controller) in accordance with embodiments of the invention uses two inputs: a sensed output current (I_{o_Sense}) and a sensed input voltage (V_{in_Sense}). Any suitable current sensors may be used with embodiments of the invention for sensing the output currents. For example, in the embodiment of FIG. 2, a small sense resistor 120 is used to sense the output current 124 to feed to the input of flicker controller 112. For the other input to the flicker controller 112, a loop 138 is used to sense the input voltage (V_{in_Sense}) to feed the flicker controller 112.

In accordance with embodiments of the invention, the DC-DC converter 114 may be operated in a discontinuous conduction mode (DCM). In this discontinuous conduction mode of operation, the converter behaves as a resistor emulator, which will maintain a high displacement PF. It is well known that the PF has two factors: a displacement factor and a distortion factor. By operating the converter in DCM, the displacement factor is about unity. Therefore, any significant deviation effect on the PF will be from the distortion factor. For this reason, using the harmonics injection technique to introduce more harmonics into the input current may further decrease the PF. Consequently, the harmonics injection values should be carefully predefined for a proper design. In accordance with embodiments of the invention, the injected harmonic values are pre-defined by the regulated flicker controller 112 such that the LED driver 100 would comply with the Energy Star standard, which has a PF more than 0.9. The predefined harmonic values may be based on the second order and higher order harmonics of the line frequency.

The regulated flicker controller 112 is a control circuit that has several functions, including current regulation of the average current value for the LED chip. One of the LED chip current characteristics is that its average current value should be constant. The LED module 118 has a light intensity characteristic that is proportional to the average current passing through it. Therefore, the regulated flicker controller 112 is used to regulate the average of the LED output current 124 for a nominal value and nominal lumen.

The regulated flicker controller 112 has two input ports as shown in FIG. 2, wherein the first port is used to sense the output current 124 by using a small sense resistor 120, and the second port is used to sense the input voltage. Moreover, the regulated flicker controller 112 may be used to inject predefined harmonics to the control loop. Due to the low energy density of the output capacitor 116, the shape of the output current 124 has a significant harmonic value of double line frequency with other values of high order harmonics. The flicker controller 112 may be used to predefine a harmonic value, which may be derived from the double to a higher order (e.g., the tenth) of the line frequencies of the output current 124. Then, based on these predefined harmonic values, a unique shape of an output 140 from the flicker controller 112 is used to reshape the output current 124 to minimize the harmonic distortions. That is, a predefined harmonic value, which is derived from the second to higher order harmonics, is used to reshape the output current 124 such that the output current 124 has no or minimal distortion.

The LED drivers preferably are operated and featured as universal input voltage, wherein the input voltage can be changed within a range (e.g., from 85 Vrms to 265 Vrms). For this reason, the input voltage is sensed by a sensing loop 138, and the sensed voltage is input to the regulated flicker controller 112. The regulated flicker controller 112 can adapt the gain of a compensator to sustain the input voltage change. Consequently, the control circuit operating point may be changed for each input voltage, which makes it applicable for a universal input LED driver, where it can work in different countries without the needs for modification or presetting.

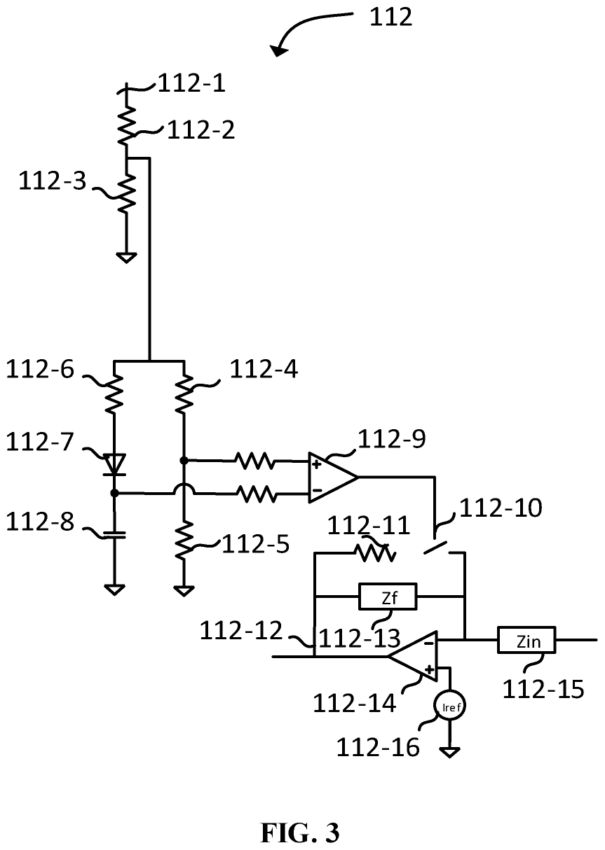

FIG. 3 shows one example of a regulated flicker controller 112 that comprises a circuit added to the power stage to implement a universal input voltage feature. The flicker controller 112 has two loops: one loop is to sense the output current, which is regulated by a compensator (112-10-112-16) that has an input impedance of Zin 112-15 and a feedback impedance of Zf, 112-13, and the other loop is to sense the input voltage by using a voltage simple divider (consisting of resistors 112-2 and 112-3) of the rectified voltage 112-1. The sensed rectified voltage can be processed to detect its peak by a peak detector circuit that comprises a current limiter resistor 112-6, a diode 112-7 and a capacitor 112-8. A comparator 112-9 is used to distinguish between the two input voltages mode by comparing the peak of the sensed input voltage and a reference voltage. The output of the comparator 112-9 controls a switch 112-10 that is connected in series with an extra compensator resistor 112-11 to change its gain online.

The comparator output is connected to a switch to add an extra resistor to its transfer function, which is responsible for the compensator gain change. In DCM operation of a controller of the invention, there are two regions for the input voltage operations. The first region has a gain that is defined by the compensator when the comparator output is low. The second region needs a different gain due to the change in the input voltage, which makes the comparator output voltage high and connects another resistor in parallel connection with the compensator main impedance to change the gain. The needed gain is predefined by the required harmonics needed to maintain a lower flicker value and high-power factor at the same time.

In fact, the LED current 124 peak may increase because the output capacitor 116 has a lower energy density than an electrolytic capacitor. Passing a high peak current through the LED chip module 118 has a bad effect on the chip, such as a color-shift phenomenon that makes the color of the LED module 118 shifting to the bluish white color. Another bad effect is that the flux of the LED module 118 is saturated, which makes the operating point act on its peak value and leads to flux saturation and decreases the efficacy of the LED module 118. In addition, it causes failure of the LED module 118 due to higher current peak values. This failure could also happen due to cracks in the golden wire bond.

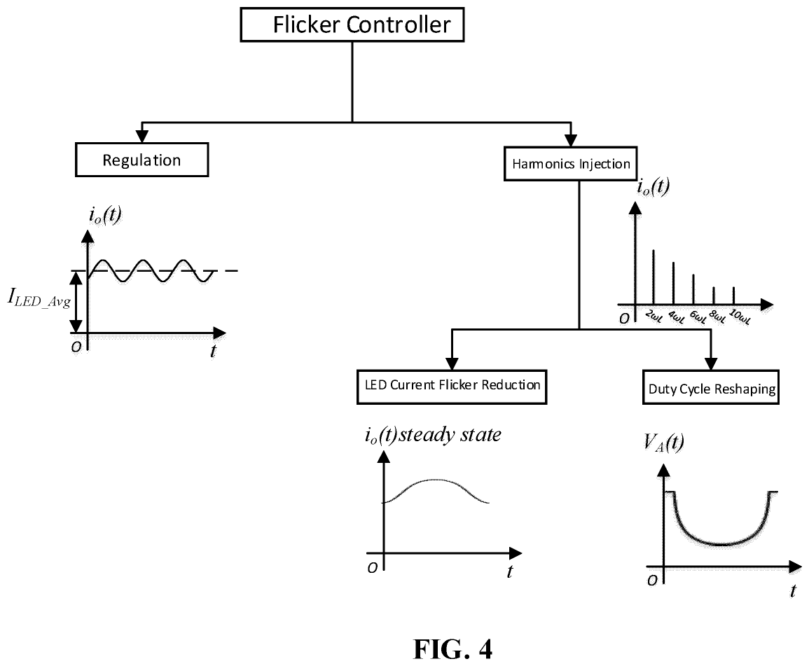

FIG. 4 shows a schematic illustrating the functions of a flicker controller according to one embodiment of the invention. First, the flicker controller is used for current regulations to regulate the average of the LED currents. The second and third functions, by harmonics injection, are to apply flicker controls to reduce the LED flicker percentage value to a low value (e.g., less than 30% based on the California standards) and to adjust the required duty cycle to maintain a high power factor (e.g., PF more than 0.9) through reshaping the sensed output signal by injecting a predefined harmonics value. A predefined harmonics value may be based on a combination of harmonics having frequencies that are double to higher-order (e.g., 10th order) multiples of the base frequency. The example shown in FIG. 4 illustrates second-order (2ωL), fourth-order (4ωL), sixth-order (6ωL), eighth-order (8ωL), and tenth-order (10ωL) harmonics. For example, a predefined harmonic value may be based on a combination of the values of these harmonics.

As described above, embodiments of the invention use an AC-DC electrolytic capacitor-less converter with a novel control circuit to drive LED chip with required regulated current and decreased lighting flicker. Advantages of embodiments of the invention may include one or more of the following. An LED driver power converter has a low energy density capacitor (such as film or ceramic) to maintain a longer lifetime LED lamp than the conventional LED driver that uses an electrolytic capacitor. Using a low energy density capacitor in the LED driver requires special attentions to the flicker percentage, where it should be controlled to be lower than a certain standard value, such as California title 24 flicker standard. A flicker controller of the invention has a unique combination between the ability of using harmonics injection technique and LED current reshaping to comply with regulations, such as California title 24 for flicker standard. Furthermore, boosting the power factor value and the input current harmonics to comply with the energy star standard and IEC61000 3-2 CLASS C may be achieved by using the novelty of this regulated flicker controller. Finally, a regulated flicker controller of the invention enables the LED driver to operate with a wide input voltage values; this feature has an advantage to increase the market penetration and usage in different countries with different AC level voltages and frequencies.

Embodiments of the invention have been described with a limited number of examples. One skilled in the art would appreciate that these examples are for illustration only and other modifications and variations are possible without departing from the scope of the invention. Accordingly, the scope of protection should only be limited by the attached claims.

What is claimed:

1. An LED driver system for driving an LED chip or a string of multiple LED chips, the LED driver system comprising:
an EMI filter with two ports, wherein a first port of the EMI filter is connected to a line voltage;
a rectifier bridge with two ports, wherein a first port of the rectifier bridge is connected to a second port of the EMI filter;
a DC-DC power converter with two ports, wherein a first port of the DC-DC power converter is connected to a second port of the rectifier bridge;
an output stage connected to a second port of the DC-DC power converter; and
a flicker controller comprising two input ends and one output end, wherein a first input end is connected to an output stage to sense a signal indicative of an output current,
wherein the one output end is connected to a switch of the DC-DC power converter,
wherein the second input end is connected to a common coupling point of a voltage divider circuit to sense an input voltage.

2. The LED driver system of claim 1, wherein the flicker controller is used as a regulator with a specified bandwidth of 100-500 Hz to regulate the LED output current.

3. The LED driver system of claim 1, wherein the flicker controller is used to inject a predefined harmonic to a control loop such that an output current flicker and an output current peak to average ratio (PTAR) are limited.

4. The LED driver system of claim 1, wherein the flicker controller is configured to perform duty cycle shaping.

5. The LED driver system of claim 1, wherein the flicker controller is configured to perform output current shaping.

6. The LED driver system of claim 1, wherein the flicker controller is implemented using a second order compensator.

7. The LED driver system of claim 1, wherein the flicker controller is implemented using a third order compensator.

8. The LED driver system of claim 1, wherein the flicker controller is implemented using a fourth order compensator.

9. The LED driver system of claim 1, wherein the DC-DC power converter is configured to transfer a power from an input port to a regulated output port.

10. The LED driver system of claim 9, wherein a topology of the DC-DC power converter has an intermediate storage capacitor.

11. The LED driver system of claim 9, wherein a topology of the DC-DC power converter is a single-switch converter.

12. The LED driver system of claim 9, wherein a topology of the DC-DC power converter is a two-stage converter.

13. The LED driver system of claim 10, wherein the capacitor is a ceramic capacitor.

14. The LED driver system of claim 10, wherein the capacitor is a film capacitor.

15. The LED driver system of claim 1, wherein the output stage comprising:
an LED inductor comprising a first end and a second end, wherein the first end of the LED inductor is connected to a first common coupling point, where a first end of the capacitor is also connected;
an LED module comprising a LED chip or a string of multiple LED chips, wherein the LED module has an anode and a cathode, wherein the anode of the LED module is connected to the second end of the LED inductor; and
a sense resistor comprising a first end and a second end, wherein the first end of the sense resistor is connected to the common coupling point, where the cathode of the LED module and the first input end of the flicker controller are connected, and the second end of the sense resistor is connected to ground.
